(19) United States
(12) Patent Application Publication
(10) Pub. No.: US 2017/0067514 A1
(43) Pub. Date: Mar. 9, 2017

(54) Mounting Carrier for an Opening Roller with Parts of a Securing Device for a Screw Cap and an Opening Roller with a Securing Device for a Screw Cap

(71) Applicant: Rieter Ingolstadt GmbH, Ingolstadt (DE)

(72) Inventor: Josef Schermer, Bergheim-Unterstall (DE)

(21) Appl. No.: 15/255,824

(22) Filed: Sep. 2, 2016

(30) Foreign Application Priority Data
Sep. 4, 2015 (DE) 10 2015 114 872.2

(51) Int. Cl. F16D 1/06; D01H 5/56

(52) U.S. Cl. CPC F16D 1/06; D01H 5/565

(57) ABSTRACT

A mounting carrier (3) for an opening roller (1) of an open-end spinning device features at least one part of a screw cap (8) comprising multiple positions, by means of which the mounting carrier (3) can be detachably fastened to a base body (2) of the opening roller (1) firmly connected to a drive shaft (6). Furthermore, the mounting carrier (3) features at least one part of a securing device (7). The securing device (7) includes a cover element (15) connected to the mounting carrier (3), by means of which at least one of the positions of the screw cap (8) can be indicated, and/or by means of which the mounting carrier (3) can be secured against unintentional detachment from the base body (2). An opening roller (1) features a base body (2) firmly connected to a drive shaft (6) and a mounting carrier (3) detachably connected to the base body (2) by means of a screw cap (8), whereas the screw cap (8) features multiple positions and, by rotating the mounting carrier (3) relative to the base body (2) around a common axis of rotation (A), can be transferred from a disengaged position (I) through a connecting position (II) into a locking position (III), and back. The screw cap (8) comprises at least one securing device (7), which includes one cover element (15) connected to the mounting carrier (3), which, at least in the connecting position (II), indicates the position of the screw cap (8), and/or which, at least in the connecting position (II), secures the mounting carrier (3) against unintentional detachment from the base body (2).

The present invention relates to an opening roller for an open-end spinning device with a base body firmly connected to a drive shaft and with a mounting carrier detachably connected to the base body by means of a screw cap. The screw cap features multiple positions and, by rotating the mounting carrier relative to the base body around a common axis of rotation, can be transferred from a disengaged position through a connecting position into a locking position, and back. The screw cap comprises at least one securing device. The present invention further relates to a corresponding mounting carrier for an opening roller of an open-end spinning device, which features at least one part of a screw cap and at least one part of a securing device.

For opening rollers for open-end spinning devices, it is always necessary to detachably connect the mounting carrier to the base body, in order to quickly replace the mounting upon a change to the application or when wear arises. Thereby, it is necessary to ensure a reliable transfer of torque from the base body to the mounting carrier that withstands the loads during operation. Likewise, the formation of a gap in the connecting areas between the mounting carrier and the base body must be avoided, in order to prevent the entrapment and accumulation of fibers. Therefore, the connection between the mounting carrier and the base body is of considerable importance.

Opening rollers with which the mounting carrier and the base body are connected to each other in the axial direction of the opening roller by means of screws are already known in the state of the art. With such opening rollers, the transfer of torque from the base body to the mounting carrier thus depends on the axial clamping force. If there is insufficient axial clamping force, the formation of gaps and the laying down of fibers may also arise.

An opening roller with which the base body and the mounting carrier are connected to each other in the axial direction by means of a clip connection is known from EP 2 028 299 B1. The replacement of the mounting carrier and the mounting may take place in a particularly simple manner. In order to ensure a reliable transfer of torque, a positive-locking connection between the base body and the mounting carrier in the circumferential direction is also provided. With this version, the transfer of torque is indeed ensured, but, due to the axial clip connection, the axial holding force is relatively low.

Therefore, EP 2 617 882 A1 proposes an easily detachable screw cap between the mounting carrier and the base body. Thereby, the screw cap features a disengaged position, in which the mounting carrier and the base body can be pushed into each other in the axial direction, but are not connected to each other. By rotating the mounting carrier relative to the base body, the screw cap is brought into a locking position, in which the mounting carrier and the base body are connected to each other in a positive-locking manner in the axial direction of the opening roller, and are braced against each other, such that the mounting carrier is securely fastened to the base body. Upon the transfer of the screw cap into the locking position, a connecting position is traversed, in which there is already a loose connection between the mounting carrier and the base body, but the two parts are not yet locked together. If the screw cap is not completely transferred into the locking position, the screw cap is in the connecting position, in which there is a risk that, in the operation of the opening roller, the mounting carrier detaches from the base body.

Therefore, DE 10 2013 103 035 A1 has already proposed a screw cap with a securing device, in order to prevent the unintended detachment of the mounting carrier from the base body. However, due to the securing device, the handling of the screw cap is made difficult.

Therefore, the task of the present invention is to propose an opening roller with a screw cap and a securing device for the screw cap, which enables comfortable handling. Furthermore, a corresponding mounting carrier is to be proposed.

The task is solved with the characteristics of the independent claims.

An opening roller for an open-end spinning device features a base body firmly connected to a drive shaft and a mounting carrier detachably connected to the base body by means of a screw cap. The screw cap features multiple positions and, by rotating the mounting carrier relative to the base body around a common axis of rotation, can be transferred from a disengaged position through a connecting position into a locking position, and back. Thereby, the screw cap comprises at least one securing device. A corresponding mounting carrier for such an opening roller features at least one part of a screw cap comprising multiple positions, by means of which the mounting carrier can be detachably fastened to a base body of the opening roller firmly connected to a drive shaft. Furthermore, the mounting carrier features at least one part of a securing device.

With the mounting carrier, it is now provided that the securing device includes a cover element connected to the mounting carrier, by means of which at least one of the positions of the screw cap can be indicated, and/or by means of which the mounting carrier can be secured against unintentional detachment from the base body. With the opening roller, it is accordingly provided that the securing device includes one cover element connected to the mounting carrier, which, at least in the connecting position, indicates the position of the screw cap, and/or which, at least in the connecting position, secures the mounting carrier against unintentional detachment from the base body. In contrast to known securing devices of the state of the art, with which the securing device is a component of the screw cap, it is now proposed to design the securing device separately from the screw cap itself or from the connecting and locking elements of the screw cap, and to arrange it on a cover element of the mounting carrier, Thereby, the securing device acts completely independently of the screw cap, such that the handling of the screw cap is significantly facilitated, and the risk of operating error is reduced. Since the securing device operates independently of the screw cap, even when there is wear on the screw cap after a prolonged operating time, it may also still secure the connection between the mounting carrier and the base body.

For the opening roller, it is advantageous if the cover element, at least in the connecting position, interacts with a part of the screw cap arranged on the base body, in particular with a leaf spring, and/or with an end area of the drive shaft. With the mounting carrier, the cover element is accordingly formed to interact with a part of the screw cap arranged on the base body and/or with an end area of the drive shaft of the opening roller. The cover element of the mounting carrier can be changed by the interaction with the part of the screw cap arranged on the base body, for example in its position relative to the mounting carrier, and thereby indicates the positions of the screw cap. For this purpose, the cover element is arranged on this movably, in particular movably in an axial direction of the opening roller and/or the mounting carrier. The cover element may interact, for example, with one or more leaf springs, which are arranged on the base body and form a part of the screw cap. Alternatively or additionally, the interaction with the part of the screw cap arranged on the base body part may also include a positive-locking engagement of parts of the cover element and parts of the base body, in order to secure the mounting carrier on the base body.

It is particularly advantageous if the cover element features, on its side turned towards the mounting carrier, at least one securing element. The at least one securing element may be formed, for example, for the positive-locking interaction with a part of the base body. Alternatively or additionally, the at least one securing element may also be formed to interact with a part of the screw cap, in order to indicate the position, at least one of the positions, of the screw cap.

It is advantageous if the at least one securing element is formed as an extension of the cover element, since the cover element may thereby be manufactured in a simple manner.

According to a first version of the cover element, the at least one securing element is formed as a cylindrical extension of the cover element. A cover element with such an extension is also particularly easy to manufacture.

Thereby, it is advantageous if the at least one extension features a starting slope. Thereby, the starting slope features an angle different from 90° and from 0° to the axis of rotation of the opening roller and/or to the axis of rotation of the mounting carrier. Thus, the starting slope can slide along a part of the screw cap to the base body, in particular to a leaf spring, and thereby move the cover element relative to the mounting carrier. Thus, the cover element is capable of indicating at least one of the positions of the screw cap.

It is thereby advantageous if the cover element features a color coding for indicating the position of the screw cap. Thus, the operator can easily recognize whether the mounting carrier is securely fastened to the base body, and/or whether the screw cap has been correctly transferred into the locking position or is still in the connecting position.

According to an additional version of the invention, the at least one securing element may engage in the connecting position in a circumferential groove of the end area of the drive shaft. Thereby, the cover element secures the mounting carrier, in the axial direction of the opening roller, on the base body or on the drive shaft.

Likewise, it would also be possible that the cover element and the end area of the drive shaft interact in a purely force-fitting manner. For example, in this case, the at least one securing element of the cover element encloses the end area of the drive shaft at its outer circumference so narrowly that, due to the frictional force between the end area and the securing element, the cohesion of the components of the opening roller is ensured.

However, it is particularly advantageous if the securing element of the cover element and the end area of the drive shaft, in particular a circumferential groove of the end area, interact in combination in a positive-locking and force-fitting manner in the axial direction of the opening roller. Such a version of a securing device is to operate with a comfortable operating force, whereas good axial cohesion is still effected, due to the positive connection.

If the securing element engages at least in the connecting position in a circumferential groove of the end area of the drive shaft, it is advantageous if the at least one securing element can be introduced through a movement of the mounting carrier in the axial direction of the opening roller in the circumferential groove of the end area. It is thereby particularly advantageous that, upon the assembly of the mounting carrier to the base body in the axial direction, the securing device is also automatically and independently actuated. Therefore, the handling of the opening roller with such a securing device is particularly comfortable and safe. In doing so, the risk of operating error is greatly reduced.

It is further advantageous if the cover element features, on its side turned towards the mounting carrier, multiple securing elements formed as latching hooks, which are in particular arranged opposite to each other or in a circular manner around the axis of rotation. Upon the assembly of the mounting carrier with the base body, they are initially automatically put over the outer circumference of the end area of the opening roller, whereas, subsequently, through the snapping in of the latching hooks in the circumferential groove of the end area, it is ensured at the same time that the screw cap can be properly closed. It is also thereby advantageous that, through the snapping in, the successful actuation of the securing device is signaled to the operator.

In order to connect the cover element to the mounting carrier, it is also advantageous if the cover element has, on its side turned towards the mounting carrier, multiple clip elements. The cover element is thereby snapped into the mounting carrier in a secure and positive-locking manner, but, when necessary, may still be easily replaced, for instance, if, after a prolonged operating time, the securing force of the securing elements has diminished On its side turned towards the mounting carrier and/or the mounting, the cover element during operation shows the opening roller to the outside and is thus freely accessible.

If the securing element interacts at least in the connecting position with a circumferential groove of the end area of the drive shaft, according to an additional advantageous version, it is advantageous if the at least one securing element can be introduced by a rotational movement of the cover element in the circumferential groove of the end area. Thereby, the operation of the securing device is in turn particularly advantageous, since, in one move, the installation of the mounting carrier on the base body can be effected by means of the screw cap and the actuation of the securing device can be effected by means of a rotary movement.

In order to actuate the securing element by means of a rotational movement of the cover element, it is advantageous if the cover element is connected to the mounting carrier in a rotatable manner, preferably in a rotatable manner with limits. Thereby, the securing element can be actuated by means of a short pivoting movement of the cover element with respect to the mounting carrier. Thus, for an opening roller, with which the drive shaft features an end area with a circumferential groove, the least one securing element may thus be introduced by means of a rotational movement of the cover element in the circumferential groove.

Thereby, it is particularly advantageous if at least one of the clip elements is guided in a gate of the mounting carrier. In doing so, the risk of operating error is further reduced. Thereby, it is further advantageous if an additional clip element forms the pivot point, around which the cover element is guided in a pivoting motion by means of the clip element guided into the gate. Thereby, an eccentric pivoting movement of the cover element in respect of the mounting carrier is achieved, which still delivers additional optical and tactile feedback as to whether the securing device has been pressed.

Therefore, with this version, it is particularly advantageous if the at least one securing element is formed in a sickle shape. Such a securing element can be pivoted, in a simple manner, by means of the above-described short pivoting movement of the cover element from the radial direction into the groove of the end area of the drive shaft.

Additional advantages of the invention are described on the basis of he following presented embodiments. The following is shown:

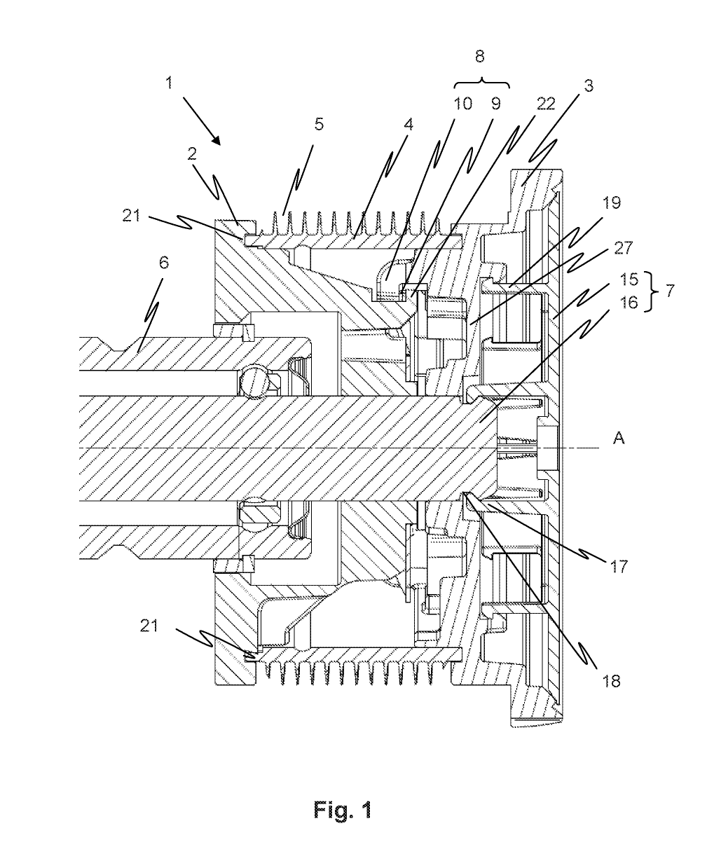

FIG. 1 an opening roller with a base body and a mounting carrier in an assembled state, in a schematic sectional view,

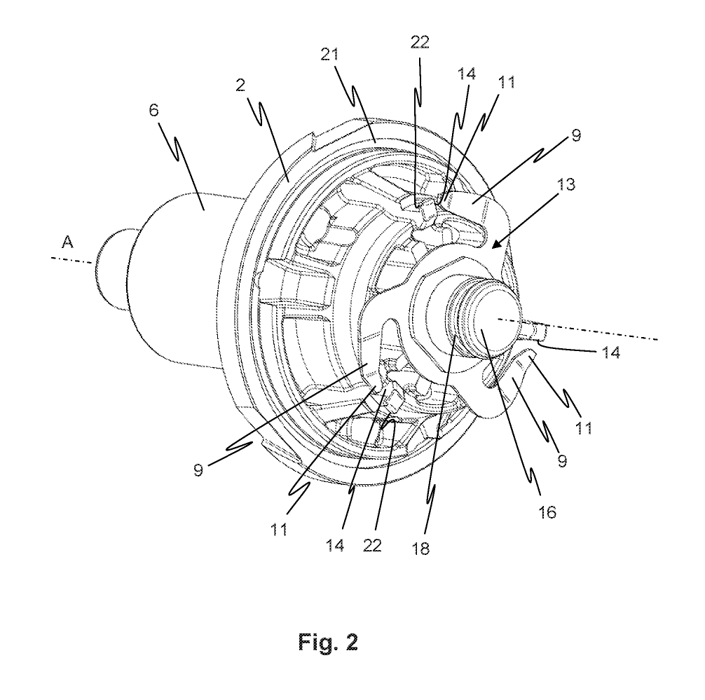

FIG. 2 a perspective view of a base body of the opening roller with connecting elements of a screw cap,

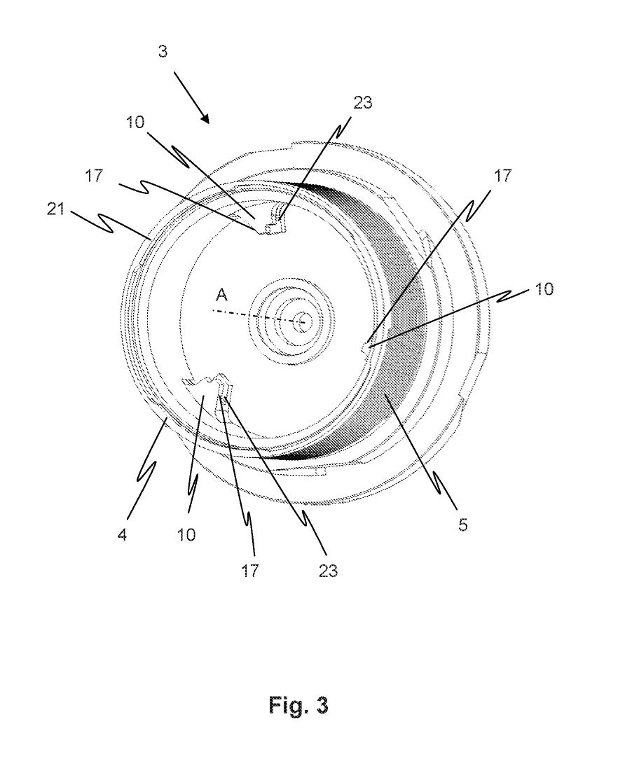

FIG. 3 a perspective view of a mounting carrier of an opening roller with locking elements of a screw cap,

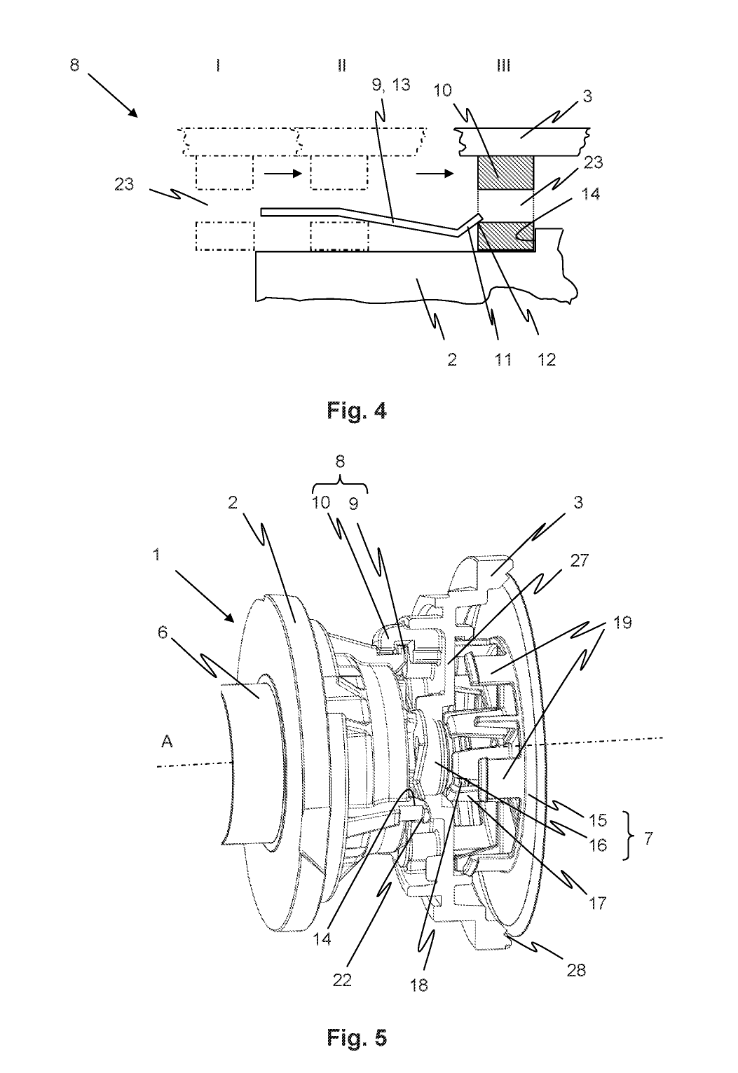

FIG. 4 a schematic sectional view of the screw cap in a locking position,

FIG. 5 a schematic sectional view of an opening roller with a two-piece mounting carrier in an assembled state, in a sectional view,

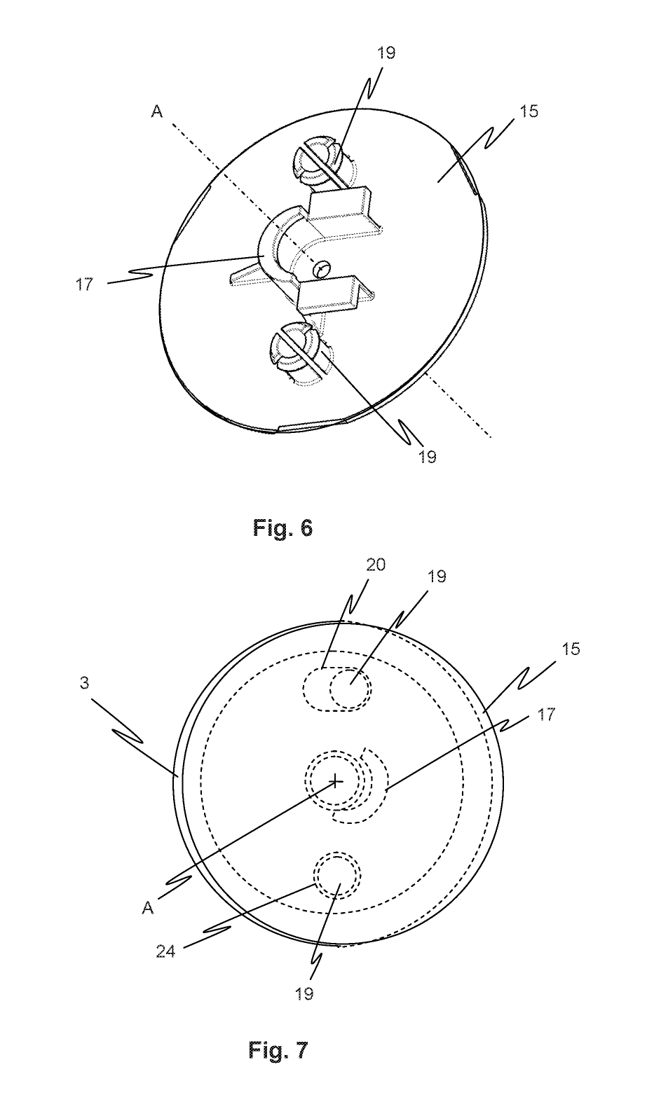

FIG. 6 a detailed perspective view of a cover element with a securing element,

FIG. 7 a schematic view of a mounting carrier with a cover element along with a gate for the cover element,

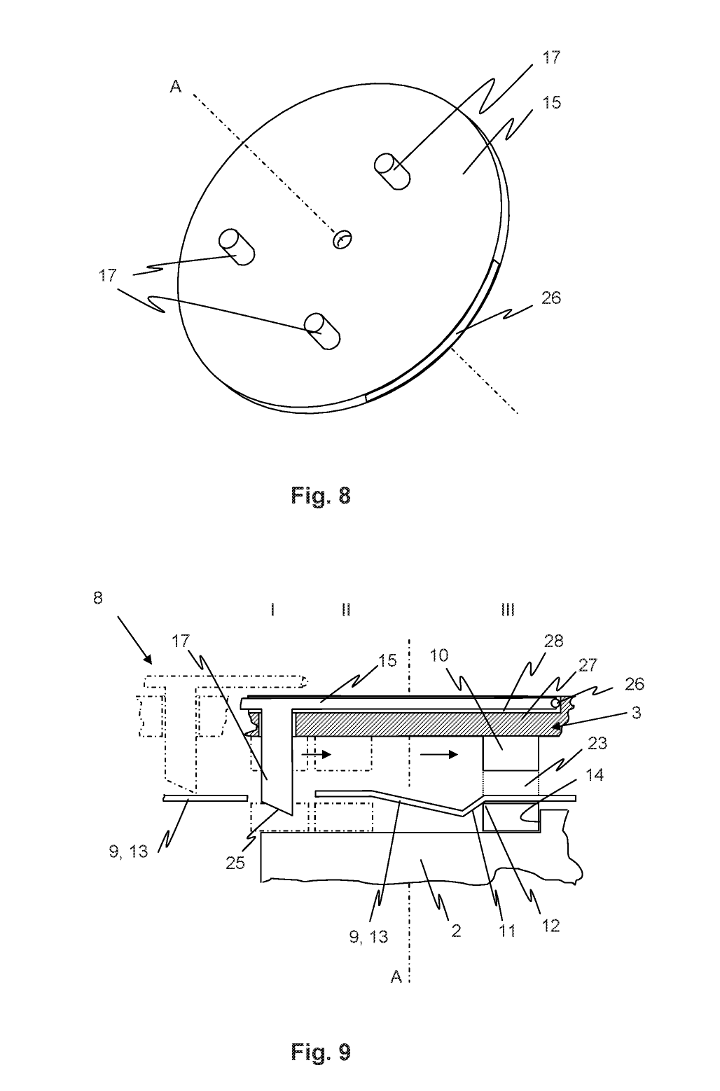

FIG. 8 a detailed perspective view of a cover element with multiple securing elements according to an additional version, and

FIG. 9 a schematic view of the functioning of the cover element of FIG. 8.

FIG. 1 shows a perspective view of an opening roller 1, with which a base body 2 and a mounting carrier 3 are connected to each other by means of a screw cap 8. In the present case, the base body 2 and the mounting carrier 3 are shown in operational state, in which the screw cap 8 is in its locking position III (see also FIG. 4). The base body 2 and the mounting carrier 3 are rotatable around a common axis of rotation A. The mounting carrier 3 includes a mounting bracket 4 on which, in turn, the mounting 5 is arranged. In the present example, the mounting bracket 4 is formed in one piece with the mounting carrier 3. However, it is also possible to form the mounting bracket 4 separately from the mounting carrier 3, in the form of a mounting ring, as shown in FIG. 5. The base body 2 is connected in a torque-proof manner to a drive shaft 6, which in turn is rotatably mounted in the open-end spinning device (not shown).

In order to quickly replace the mounting 5 or the mounting carrier 3, the mounting carrier 3 is connected to the base body 2 by means of an easily detachable screw cap 8. Such a replacement of the mounting 5 or the mounting carrier 3 is required, for example, upon a change to the application during the operation of the open-end spinning device or even upon the wear of the mounting 5. In the present case, the screw cap 8 is formed by multiple connecting elements 9 of the base body 2 (shown in FIG. 2) along with multiple locking elements 10 of the mounting carrier 3 (shown in FIG. 3). For fastening the mounting carrier 3 on the base body 2, the mounting carrier 3 and the base body 2 can be pushed into each other, or removed from each other, in the axial direction, that is, in the direction of the axis of rotation A of the opening roller 1. For this purpose, the screw cap 8 must be in a disengaged position I (see FIG. 4), in which the axial assembly or axial disassembly of the base body 2 and the mounting carrier 3 is possible.

As the base body 2 and the mounting carrier 3 were assembled by axially pushing them together, the screw cap 8 may be transferred by rotating the mounting carrier 3 relative to the base body 2 from the disengaged position I through a connecting position II into the locking position III (see FIG. 4), in which the base body 2 and the mounting carrier 3 are now connected to each other in a positive-locking manner in the axial direction of the opening roller 1, such that the detachment of the mounting carrier 3 from the base body 2 is ruled out. The positive-locking connection in the axial direction may also be clamped in the axial direction, such that it no longer has axial backlash. In addition, the base body 2 and the mounting carrier 3 are also connected to each other in the circumferential direction of the opening roller 1 by means of the screw cap 8, such that a torque can be transferred from the base body 2 to the mounting carrier 3. For this purpose, the base body 2 and the mounting carrier 3 may be clamped to each other solely in the axial direction, such that a frictional connection arises in the circumferential direction between the friction surfaces 21 of the base body and the friction surfaces 21 of the mounting carrier 3. However, as an alternative or in addition to the force-fitting connection in the circumferential direction, a form-fitting connection between the base body 2 and the mounting carrier 3 may also be provided in the circumferential direction, in order to transfer the torque from the base body to the mounting carrier.

Furthermore, FIG. 1 shows a first version of a securing device 7, which comprises a cover element 15 with multiple securing elements 17, which engage in a circumferential groove 18 of an end area 16 of the drive shaft 6. The exact functioning of the securing device 7 is explained below with the help of FIG. 5.

FIG. 2 shows a perspective view of the base body 2, which, as part of the screw cap 8, features at least one connecting element 9. FIG. 2 further shows the drive shaft 6, with which the base body 2 is firmly connected, along with an axial stop 22 for a locking element 10 of the mounting carrier 3. In the present view, three connecting elements 9 along with three axial stops 22 are shown. However, more or fewer connecting elements 9 may be present. In the present case, the connecting elements 9 are each formed by a single leaf spring 13. Likewise, however, the connecting elements 9 could be formed by individual leaf springs 13, or could be designed in other ways.

FIG. 3 shows a perspective view of a mounting carrier 3, which in turn is formed in one piece with the mounting bracket 4 On its inner circumference or the inner circumference of its mounting bracket 4, the mounting carrier 3 features multiple locking elements 10, which are formed to interact with the connecting elements 9 of the base body 2. In the present case, each of the locking elements 10 features an opening 23 for interacting with the connecting elements 9 of the base body 2. In the present case, three locking elements 10 are shown in turn. Likewise, however, a different number of locking elements 10 may be present.

The functioning of the screw cap is now described with the help of FIG. 4. As can be seen from the schematic view, the screw cap 8 features a disengaged position I (shown with a dash-dot line). In this position, the mounting carrier 3 and the base body 2 can be joined together in the axial direction or removed from each other in the axial direction, since the connecting elements 9 and the locking elements 10 do not encounter each other in the disengaged position I. As the mounting carrier 3 has been set, with the locking elements 10, onto the base body 2 in the axial direction, the mounting carrier 3 may now be rotated relative to the base body 2, as symbolized by the arrows. The connecting elements 9, formed in the present view by the leaf springs 13, thereby reach the opening 23 of the locking elements 10. The screw cap 8 is now located in the connecting position II, in which there is a loose connection between the base body 2 and the mounting carrier 3 in the axial direction. In this connecting position II, however, there is no torque-transferring connection in the circumferential direction. In the connecting position II, however, there is always the risk that the mounting carrier 3 will be rotated relative to the base body 2 and thereby once again slip into the disengaged position I. Only if the screw cap 8 is further rotated beyond the connecting position II into the locking position III will there be a secure connection of the mounting carrier 3 to the base body 2, since the connection is locked. For this purpose, according to the present view, the connecting element 9 is provided with a latching element 11, which interacts with a latching edge 12 of the locking element 10. Thereby, the latching element 11 presses the locking element 10 against a circumferential stop 14 of the base body 2. However, the connection may also be locked, without such a latching element 11, solely by means of axial clamping, which is possible, for example, through a corresponding shaping of the leaf spring 13 or the leaf springs 13. However, an axial clamping by means of an additional spring element is conceivable, for example, if the connecting elements 9 are not designed as leaf springs 13.

In order to prevent the opening roller 1 from being taken into operation, although the screw cap 8 is not properly locked and is only in the connecting position II, the securing device 7 is provided. At least in the connecting position II, this must indicate the position of the screw cap 8, so that improper locking is indicated to the operating personnel. Of course, it is advantageous if the securing device 7 also indicates the position of the screw cap 8 in the locking position III. According to an additional version of the securing device 7, this must secure the mounting carrier 3, at least in the connecting position II, on the base body 2 in the axial direction. Thus, the securing device 7 prevents the screw cap from unintentionally moving from the connecting position II into the disengaged position I, by which the mounting carrier 3 could detach from the base body 2 in an uncontrolled manner. It is thereby advantageous if the securing device 7 secures the mounting carrier 3 in the locking position III, since, when there is premature wear or fatigue of the connecting elements 9 or the locking elements 10, a secure locking may no longer exist under certain circumstances.

FIG. 5 shows a first version of such a securing device 7 in a sectional view. The recognizable parts here in turn are the base body 2 and the mounting carrier 3 of the opening roller 1, which, in contrast to FIG. 1, are designed in two parts with a separate mounting bracket 4 designed as a mounting ring However, in the present case, the mounting ring or mounting bracket 4 is not shown. In all other respects, the components of the opening roller 1, with the screw cap 8 along with the connecting elements 9 and the locking elements 10, correspond to those of FIG. 1, such that their functioning is not separately described here.

The securing device 7 includes a cover element 15, which in this case is connected to the mounting carrier 3 by means of multiple clip elements 19. On its side turned towards the mounting carrier 3, the cover element 15 also features multiple securing elements 17, which are formed in the present case as latching hooks. Thereby, the securing elements 17 are arranged in a circular manner around the axis of rotation A of the opening roller 1 or of the mounting carrier 3, such that it may encompass the end area 16 of the drive shaft 6, which extends through the base body 2. The end area 16 of the drive shaft 6 features a circumferential groove 18, into which the latching hooks or securing elements 17 of the cover element 15 engage, in order to form the securing device 7.

Since the latching hooks or securing elements 17 in the radial direction of the cover element 15 are designed to be resilient and flexible, upon the axial inter-engagement of the base body 2 and the mounting carrier 3 in the disengaged position I of the screw cap 8, the securing device 7 is necessarily and automatically also actuated. Thus, in a simple manner, the securing elements 17 can be brought into the circumferential groove 18 of the end area 16 in the axial direction by means of a movement of the mounting carrier 3. The circumferential groove 18 is preferably not designed as a rectangular groove, but is designed to be conical with rising groove flanks, such that the detachment of the securing device 7 is possible with relative ease. Preferably, the groove flanks of the circumferential groove 18 are thereby formed so steeply that the securing device 7 counteracts a detachment of the mounting carrier 3 from the base body 2 by means of gravity. Only when applying a significantly higher actuating force is it possible to slip the latching hooks or the securing elements 17 out of the circumferential groove 18 in order to release the connection. The functioning of the securing device 7 of FIG. 1 is identical to the functioning described here.

With this securing device 7, it is advantageous that the securing device 7 is fixed to the mounting carrier 3, not only in the connecting position II, but also in the locking position III, at the base body 2. If the screw cap 8 is moved from the locking position III, through the connecting position II, in turn into the disengaged position I, the securing device 7 is still active, since the securing elements 17 are still engaged with the circumferential groove 18. Thus, a defined axial force is required to pull the mounting carrier 3 from the base body 2. Thus, with the described securing device 7, an unintentional detachment of the mounting carrier 3 from the base body 2 can be almost completely ruled out. With this securing device 7, it is also particularly advantageous that the successful actuation of the securing device 7 is signaled by the snapping of the latching hooks or securing elements 17 into the circumferential groove 18. Therefore, operating error is like-wise nearly ruled out.

FIGS. 6 and 7 show an additional version of the invention, with which the securing element 17 can be pivoted not through an axial movement, but through a rotational movement of the cover element 15 into the circumferential groove 18 of the end area 16. The cover element 15 is also provided on its side with clip elements 19 allocated to the mounting carrier 3, by means of which it is connected to the mounting carrier 3, which is shown in FIG. 7. In addition, the cover element 15, on its side turned towards the mounting carrier 3, features a securing element 17, which in the present case is formed in a sickle shape.

FIG. 7 shows a view of the mounting carrier 3 on its side turned towards the base body 2 and the mounting bracket 4, which, during operation, shows the opening roller 1 to the outside and in which the cover element 15 can be inserted.

For this purpose, the mounting carrier 3 features a latching opening 24, in which one of the clipped elements 19 can be clipped. Furthermore, the mounting carrier 3 features a gate 20, in which an additional clip element 19 can be clipped in the axial direction of the mounting carrier 3 or the opening roller 1, and is thereby guided around the first opening 23 in a rotatable manner with limits. It is thus possible to pivot the cover element 15 inserted in the mounting carrier 3 by a low angle relative to the mounting carrier 3. In the present case, the securing device 7 is shown in an unlocked position, in which the safety element 17 is not engaged with the circumferential groove 18 of the end area 16.

If the mounting carrier 3 is now connected to the base body 2 already connected with it to the cover element 15 in the axial direction, the screw cap 8 may be actuated in the usual manner. Thereby, at the same time, a small pivoting movement of the cover element 15 is carried out, such that the sickle-shaped securing element 17 is pivoted in the circumferential groove 18, such that, in turn, a positive-locking connection with the drive shaft 6 in the axial direction of the opening roller 1 is established.

For this purpose, the circumferential groove 18 is preferably formed as a rectangular groove, such that, after the pivoting of the securing element 17, a particularly secure positive connection in the axial direction is established, which is not detachable, even upon the application of a greater actuating force. Such a securing device 7 is possible in turn for both a one-piece mounting carrier 3 and a two-piece mounting carrier 3 with a separate mounting bracket 4.

With this embodiment of the securing device 7, it is particularly advantageous that, for the actuation of the securing device 7, a separate movement is not necessary here; rather, the pivoting of the cover element 15 in one movement can be effected with the actuation of the screw cap 8. Since the cover element 15 is mounted by means of one of the clip elements 19 eccentrically with respect to the axis of rotation A of the mounting carrier, an advantageous control of the securing device 7 is also possible. If the sickle-shaped securing element 17, as shown in FIG. 7, is out of engagement with the circumferential groove 18, the cover element 15 laterally protrudes over the mounting carrier 3, as shown in FIG. 7. An assembly of the opening roller 1 in the open-end spinning device is not possible, based on the narrow dimensions with a protruding cover element 15. At the same time, the operator, both visually and tactilely can immediately recognize that the cover element 15 protrudes radially over the mounting carrier 3, and thus the securing device 7 is not actuated. Only after pivoting the cover element 15, with the securing device 7 being actuated at the same time, an assembly of the opening roller 1 in the open-end spinning device is possible. It is also advantageous here that the securing device 7 also fixes the mounting carrier 3 in the locking position III of the screw cap 8 at the base body 2, such that, even with wear of the screw cap 8, the mounting carrier 3 is securely held on the base body 2

FIGS. 8 and 9 show an additional version of the invention, with which the securing device 7 solely indicates the position of the screw cap 8, but does not secure the mounting carrier 3 at the base body 2. For this purpose, the cover element 15 may, relative to the axial direction (the direction of the axis of rotation A) of the mounting carrier 3, occupy two different positions with respect to this.

FIG. 8 shows a perspective view of a cover element 15 with parts of a securing device 7. The securing device 7 also comprises a cover element 15, which, on its side turned towards the mounting carrier 3, features multiple securing elements 17, which in the present case are formed as cylindrical extensions of the cover element 15. In the present case, 3 securing elements 17 are evenly distributed around the circumference of the cover element 15, but, in particular depending on the design and number of locking elements 9 and connecting elements 10, more or fewer securing elements 17 can be arranged. The securing elements 17 are formed in such a manner that they can interact with parts of the screw cap 8 arranged on the base body 2, and thereby can change the position of the cover element 15 relative to the mounting carrier 3 and also relative to the base body 2, if the screw cap 8 is actuated. Thereby, the changed position of the cover element 15 is easy for the operating personnel to recognize, and signals to them the positions—connecting position II or locking position III—in which the screw cap 8 is located. For this purpose, this present cover element 15 features a color coding 26, which is visible in the connecting position II and thus indicates the position of the screw cap 8 in the connecting position II.

FIG. 9 shows a schematic and partially sectional view of the screw cap 8 along with a securing device 7, as shown in FIG. 8. The basic functioning of the screw cap 8 corresponds to that of FIG. 4, such that this will no longer be addressed in detail. In addition to the locking element 10 and the connecting element 9, in a truncated view, the cover element 15 is still shown, from which, in the present case, a securing element 17 in the form of a cylindrical extension is indicated. For interacting with the leaf spring 13, the securing element 17 features a starting slope 25. The cover element 15 is arranged centrally around the axis of rotation A at the mounting carrier 3 and, similar to that shown in FIGS. 1 and 5, can be fastened to the mounting carrier 3 by means of (for example) clip elements 19 (not shown here). Furthermore, with its securing elements 17, the cover element 15 reaches through an axial end wall 27 of the mounting carrier 3.

As already described for FIG. 4, in the disengaged position I, the mounting carrier 3 can be set in the axial direction on the base body 2 (left, dash-dotted view of the locking element 10). For this purpose, the locking element 10 that is shown in the present case can be introduced into a gap between two adjacent connecting elements 9. The at least one securing element 17, which is assigned to the locking element 10 that is shown, arises on an adjacent connecting element 9 in this position. Therefore, the cover element 15 protrudes in the axial direction (direction of the axis of rotation A) over the mounting carrier 3, which can be easily recognized by the operator. In addition, a color coding 26 may be provided on the cover element 15, which signals the protrusion of the cover element 15 and thus indicates that the screw cap 8 is located only in the connecting position II or possibly still in the disengaged position I. In the present case, the color coding 26 is formed by a colored seal ring.

If the screw cap 8 is now rotated from the disengaged position I through the connecting position II into the locking position III, as already described in detail for FIG. 4, the securing element 17 slides along the adjacent connecting element 9 or the adjacent leaf spring 13 until it arrives in the gap between the two connecting elements 9. The screw cap 8 is now in the locking position III, but the cover element 15 is still protruding. The operator may now, by means of slight pressure, press the cover element 15 in the axial direction into a recess 28 of the mounting carrier 3, such that the cover element 15 no longer protrudes and the color coding 26 is also covered.

Due to the seating of the securing element 17 on the connecting element 9 (or possibly even a different part of the screw cap 8 and the base body 2), the pressing down of the cover element 15 into the recess 28 is only possible in the locking position III, such that the pressed-in cover element 15 and, if applicable, the missing color coding 26 reliably indicates the proper closure of the screw cap 8 in the locking position III. For opening the screw cap 8, the mounting carrier 3 must be rotated only in the opposite direction relative to the base body 2, such that the locking elements 10 become disengaged with the connecting elements 9. Thereby, based on the starting slope 25, the securing element 17 reaches from the gap between the two connecting elements 9 until it once again rises to the adjacent connecting element 9.

The invention is not limited to the embodiments shown. The securing device 7 that is shown is advantageous not only in conjunction with the illustrated screw cap, but can also be used in conjunction with any other screw cap. Additional variations and combinations within the scope of the claims are also covered by the invention.

### LIST OF REFERENCE SIGNS

1 Opening roller
2 Base body
3 Mounting carrier
4 Mounting bracket
5 Mounting
6 Drive shaft
7 Securing device
8 Screw cap
9 Connecting element
10 Locking element
11 Latching element
12 Latching edge
13 Leaf spring
14 Circumferential stop
15 Cover element
16 End area of the drive shaft
17 Securing element
18 Circumferential groove
19 Clip element
20 Gate
21 Friction surfaces
22 Axial stop
23 Opening
24 Latching opening
25 Starting slope
26 Color coding
27 Axial front surface
28 Recess
A Axis of rotation
I Disengaged position
II Connecting position
III Locking position

1. Mounting carrier (3) for an opening roller (1) of an open-end spinning device with at least one part of a screw cap (8) comprising multiple positions, by means of which the mounting carrier (3) can be detachably fastened to a base body (2) of the opening roller (1) firmly connected to a drive shaft (6), and with at least one part of a securing device (7), characterized in that the securing device (7) includes a cover element (15) connected to the mounting carrier (3), by means of which at least one of the positions of the screw cap (8) can be indicated, and/or by means of which the mounting carrier (3) can be secured against unintentional detachment from the base body (2).

2-16 (canceled)
